(19) United States
(12) Patent Application Publication
(10) Pub. No.: US 2009/0317776 A1
(43) Pub. Date: Dec. 24, 2009

(54) Economic Language Learning System

(76) Inventors: Gregory Keim, Broadway, VA (US); Jack August Marmorstein, Harrisonburg, VA (US); Ronald Bryce Inouye, Harrisonburg, VA (US); Michael Scott Fulkerson, Harrisonburg, VA (US)

Correspondence Address: Kaplan Gilman & Pergament LLP, 1480 Route 9 North, Woodbridge, NJ, 07095, US

(21) Appl. No.: 12/143,148

(22) Filed: Jun. 20, 2008

(51) Int. Cl. G09B 19/06; G09B 19/18; G09B 7/02

(52) U.S. Cl. 434/157; 434/110; 434/362

(57) ABSTRACT

A system of language learning applies economic theory to provide speakers and learners of each of plural languages. Remote users teach the native languages to one another by providing practice time for users seeking to learn such language. A computer keeps track of the value and cost of teaching and learning time in each language.

### TECHNICAL FIELD

This invention relates to language learning software, and more specifically, to a method and apparatus for creating an economy of language learners and teachers, with such economy preferably taking advantage of the Internet. The invention has particular application in supplying native speakers to converse with learners of a target language so the learners can practice speaking in their target languages.

### BACKGROUND OF THE INVENTION

Language learning software has become widespread and typically involves a series of tests and exercises for a learner of a target language to practice. By target language herein, we mean a language which the user is attempting to learn other than his or her native language.

Language learning exercises may present a user with images, partial sentences, or other manners in which to cause a user to practice reading and speaking in a target language. Learners may also study written material. However, it has been recognized that language learning is best accomplished by having the user communicate with native speakers on a frequent basis, in a natural setting, thereby absorbing native speaking via a process similar to osmosis.

One problem faced in the prior art is that it is difficult to locate enough native speakers of any language who are willing to devote their time to helping a language learner practice a target language. As a result, most language learners only get a real native speaking environment when they visit a country in which the target language they are attempting to learn is spoken natively. It would be desirable if language learners had a more convenient way of making native speakers available so that language learners could practice in a desired target language.

As the Internet is a worldwide medium that can transmit data, text, images, sound, etc. it would be desirable to use the Internet to link various native speakers and students of various target languages worldwide. To date, however, use of the Internet for language learning has been limited to chat rooms and the like, relatively disorganized systems for allowing users to speak with one another if and when they can find others that speak a particular language. No efficient organized system of providing language learners with native speakers of a desired target language is known to exist.

### BRIEF DESCRIPTION OF THE DRAWINGS

FIG. 1 is a flow chart showing a set of basic steps to be implemented in accordance with one embodiment of the present invention.

### DETAILED DESCRIPTION OF THE PREFERRED EMBODIMENT

In accordance with an exemplary embodiment of the invention, an online economic system for language learning is constructed in which the “currency” is backed up by language learners' of various target languages willingness and availability to teach others whose target language is the native language of the language learner, or other language in which the learner can offer instruction. Specifically, teaching time given in any particular language is assigned value, based upon the specific language, the time at which a user is willing to teach, the duration, the number of users wishing to learn such language, various parameters related to how well the user speaks a particular language, and possibly other parameters. Such other parameters may include activity, quality, demographics (age, sex, interests), teaching experience, duration, (might scale non-linearly with length, so an hour is worth 10 times what 15 minutes is worth), consistency (helping people several times a week for an extended period of time is worth more than lots of short, one time sessions, in a day) longevity (being a member for a long time increases the value of what you do), variety (more different people are more valuable, or more importantly, lots of interaction with a single person becomes devalued over time).

Some of the foregoing can also vary by time based on need/scarcity (time of day, day of week, season of the year, etc). The value may also be supplemented with actual currency, or something else of value. A central computer preferably keeps track of the value associated with teaching time in any language.

Users attempting to practice in a target language may obtain time from native speakers of that target language by themselves providing native speaking time in their own native language, or other language in which they are fluent enough to offer instruction, to others. Preferably, the centralized computer system that maintains records of values can also update the values dynamically as described in more detail below.

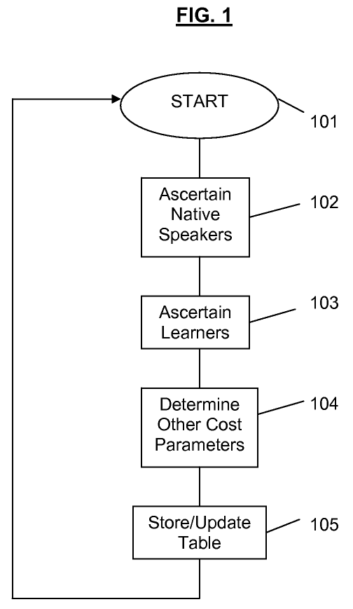

FIG. 1 shows a very basic flowchart of a system in accordance with the present invention. After starting the process at 101, blocks 102 and 103 ascertain native speakers and learners of any particular target language. One straightforward methodology of accomplishing these two steps is to permit users to sign-up and register online. Specifically, an online registration form elicits, from a user, information concerning the user's native language, as well as his or her availability to teach others whose target language is the native or other known language of the user. The user may be required to enter how much time he can teach in the native language, how much time he wishes to learn his target language, and how long he can teach, at what time of day, or other parameters.

Optionally, the user may be required to take a basic test of language skills in a particular language so the system can assess the user's ability to offer instruction in that language. The use of a test would ensure that the system independently ascertains the user's skills in any language in which the user intends to offer teaching time. Such a test would be particularly useful in situations where a user indicates that he is at least partially skilled in a language that is not his native language. If such language is a rare one, it will be worth more and a user might be tempted to overestimate his abilities in order to “buy” more practice time in his own target language.

The system can assess the user's ability in any language using a variety of known techniques, including, but not limited to, the techniques described in the copending patent applications incorporated by reference towards the end hereof. In this manner, the system itself would assign the value associated with the user's ability in any particular language, rather than letting the user do so.

The information relating to any user is recorded by the central computer system that operates the system. As described in more detail below, the system will maintain a set of values and will update values as system conditions change. The result is that the system will drive the user population towards having the correct number of language teachers and learners for each language.

Note that at block 104, other cost parameters may be gathered as well. Specifically, the system may have a prescribed monetary fee that a user must pay in order to be permitted to use it at all. Or, alternatively, a first user can increase the time he is given of a second user, which second user's native language is the target language of the first user, by paying actual money into the system. In this way, the cost and or compensation associated with learning or teaching a language, respectively, may comprise two components, one based upon reciprocal language teaching services, and another based upon actual monetary consideration. Such an arrangement allows the system more flexibility because it can pair learners and teachers with each other, even when there is a value difference, by compensating for that different with money.

After a number of such users are registered, the system can easily determine how many “user hours” of teaching time it has in any particular language. Specifically, suppose there are 100 native speakers of Portuguese, each of whom is willing to teach a student of Portuguese for approximately two hours per week. This means there are available 200 user hours of native Portuguese which can be used by the system to provide students of Portuguese with an individual to provide conversation of Portuguese by a native speaker. However, if in English, there are 500 people available, each willing to give two hours per week of teaching time, then there would be 1,000 hours per week of native English speakers, and English would be “worth” less than Portuguese.

Because of varied time zones throughout the globe, the value of teaching may vary due to the time in which the instruction is available. For example, consider a native Japanese resident of Tokyo, who is interested in learning English. Such native Japanese speaker would “pay” for his instruction by offering Japanese practice time to, perhaps, a Brazilian attempting to learn Japanese. The native Japanese speaking may be offered to the Brazilian during prescribed times of day or night. However, if the native Japanese speaker is willing to provide the Japanese instruction to the Brazilian during the late night hours in Japan, when it is day time in Brazil, the native Japanese' time will be worth more, and will thus get him more instruction in English, than it would if the native Japanese provided the same instruction with the Brazilian during the day in Japan—a less desirable time in Brazil because it is during the night.

Additionally, the skills of an individual could be rated according to a variety of parameters, such as those disclosed in copending U.S. patent application Ser. Nos. 12/133,031 and 12/052,435. These applications are hereby incorporated by reference in their entireties. The system, after measuring a user's skills, time of day available, native language, and potentially other parameters, can assign a value to the user's provision of native language practice in that user's native language to another user whose target language matches that first user's native language. The measurement of a user's skills may also be accomplished in manners other than those set forth in the above incorporated manners, and in fact, any well known prior art system of measuring language proficiency skills may be used as well.

As explained briefly above, the system may also provide an option for a user to increase or decrease the value associated with the particular language teaching such user can do, by allowing a differential to be made up with cash or other compensation. The cash system would set a reasonable value for any user's time, which value may then also be dependant upon one or more of the above parameters such as time of day, language skills, etc. Then, if a language learner and teacher are paired in a manner and at a time such that there is a value differential, the system will require one of the users to pay a specified amount if he wishes to continue with the session.

The system and method also includes a technique to dynamically update the values stored and associated with each user and/or language. For example, the system may monitor the information associated with users registered to use the system, and/or presently logged on to the system for use. If, for example, too many users whose target language is English log on and attempt to practice English at the same there may not be enough native English speakers to provide conversation. In this case, the system would temporarily increase the “cost” of English. The increase in cost has the effect that users attempting learn English would then be much better off learning it at a different time, when they can get the same amount of time from a native English speaker in exchange for a much smaller amount of their own time using their native language skills to allow users, whose target language is that native language, to practice their skills. This will tend toward equalizing the number of native and target speakers of a language at any time.

Block 105, shown in FIG. 1, may optionally be arranged to monitor activity on the network in an ongoing, dynamic fashion, and adjust the values each time users access the system in an attempt to practice language skills. Thus, at any given time, the system will preferably be tending toward ensuring there are the right number of hours available from speakers and learners of any particular language.

While the foregoing describes the preferred embodiment of the present invention, various other modifications will be apparent to those of skill in the art. For example, the techniques above may also be applied to learning other skills such as game playing, whereby an economic system can be established to teach different games that users may wish to learn. Also, written communication rather than only speech can be used in the system. Such modifications and others are intended to be covered by the following claims appended hereto.

1. A computer system for assisting users in practicing target languages, said computer system comprising a storage system for storing records associated with each user, said records including for each of at least two of said users, a native language, a target language, and a stored value associated with the target or native.

2. The system of claim 1 wherein said value is associated with the target language and is indicative of an amount of time a user can receive practicing said target language for a specified amount of practice the user can give a second user in the user's native language.

3. The system of claim 2 wherein the user's native language is the second user's target language.

4. The system of claim 1 wherein the value is a value of currency defined for use in the computer system.

5. The system of claim 4 wherein said value is based upon at least two of an amount of time, a time of day and a fluency in a language.

6. The system of claim 4 further comprising a plurality of user computer devices, wherein each user computer device includes a language learning program that evaluates a user's fluency in at least one target language, and assigns to said user a fluency level, and wherein software is included to utilize said fluency level and said target language to calculate said value.

7. The system of claim 6 wherein an available amount of time is also utilized to calculate said value.

8. The system of claim 7 further comprising software to monitor users on the system, and to adjust one or more values associated with one or more target languages based upon system usage.

9. A method comprising maintaining records of plural users, each of said users being associated with at least one target language, the method further comprising maintaining records of how much practice time to which each particular user of a target language is entitled with a user whose native language is the target language of said each particular user, and adjusting said time based upon usage of the system by plural users, and characteristics of said plural users.

10. The method of claim 9 wherein said practice time is adjusted based upon monetary value paid by at least one user.

11. The method of claim 9 wherein practice time is adjusted based upon a user with which said particular user will be permitted to practice.

12. The method of claim 11 wherein practice time is adjusted based upon practice time given to another user by said particular user in the target language of said another user.

13. The method of claim 11 wherein said practice time is adjusted also based upon said particular user's skill level in said target language of said another user.

14. A method of permitting plural language learners to practice with one another, the method comprising maintaining a computer record of values associated with each of plural languages, and updating said values based upon parameters of system users or system usage.

15. The method of claim 14 wherein said parameters include at least one of time of day, target languages of users presently using said system, native languages of users presently using said system, monetary value paid by one or more users, and skill level of one or more users in a target language of said one or more users.

16. The method of claim 15 further comprising transmitting to at least one user information indicative of how much practice time to which said user is entitled, and transmitting updated messages indicating changes in practice time to which said user is entitled as system parameters change.

17. A method of permitting plural remotely located users to practice target languages, the method comprising maintaining records of system users and languages in which they are fluent enough to permit other users to practice in, and adjusting speaker hours associated with each so that the number of speaker hours available to practice with each language tends towards the number of desired speaker hours for user wishing to practice in said language.

18. The method of claim 17 wherein values associated with speaker hours are adjusted dynamically based upon target languages and native languages of users of the system.

19. A system for attempting to provide an appropriate number of native speakers of each of plural languages to be learned by users attempting to learn such plural languages, said system comprising a processor and a database of said plural languages and a cost associated with each such language, which cost represents a cost of obtaining a specified unit of time of instruction to a user attempting to learn such language by a native speaker of such language.

20. The system m 19 wherein said cost is specified at least in part by an amount of instruction said user attempting to learn must give in a different language in which said user attempting to learn is fluent.

21. The system of claim 20 wherein said cost is further dependant upon a monetary amount.

22. The system of claim 1 wherein the stored value is dependant upon demographics associated with said users.

23. The system of claim 1 wherein said value scales non-linearly with availability.

24. The system of claim 1 wherein said value is based upon an amount of time a user has spent previously using the system as a language teacher.
